(19) United States
(12) Patent Application Publication
(10) Pub. No.: US 2010/0117386 A1
(43) Pub. Date: May 13, 2010

(54) CRANE LIFT KIT ASSEMBLY

(76) Inventor: Xi-Ren YING, Jinhua (CN)

Correspondence Address: TURNER PADGET GRAHAM & LANEY, P.A., P.O. BOX 1509, GREENVILLE, SC, 29602, US

(21) Appl. No.: 12/267,398

(22) Filed: Nov. 7, 2008

(51) Int. Cl. B66C 1/66

(52) U.S. Cl. 294/1.1

(57) ABSTRACT

A lift kit assembly is attached to a piece of portable equipment, such as a generator, so that the equipment may be hoisted or suspended by a crane. The lift kit assembly, which includes a lift ring and one or more piston assemblies, may be rotated from an upright position, suitable for lifting the portable equipment, to a flush position, suitable for storing or using the equipment. The piston assemblies have a spring constant that urges the lift ring into an upright position, which position may be released by application of a downward force to the lift ring.

### TECHNICAL FIELD

The present disclosure is directed to a lift kit for attachment to a piece of portable equipment (e.g., a generator) that provides a means by which the portable equipment may be lifted by a crane. When not in use, the lift kit may be rotated to a horizontal position, thereby reducing the overhead clearance necessary for storage of the equipment and reducing the likelihood that the lift kit assembly will be an obstruction to the use of the equipment.

### BACKGROUND OF THE DISCLOSURE

Portable power generation units, or generators, are commonly used in construction sites as an efficient means of providing electrical power for the building projects. Often, it is necessary or desirable to relocate the generator to different areas within the construction site, for example, for proximity to a work zone or for organization of the work site. Further, because these generators may be targets for theft or vandalism, construction workers may hoist the generator above the ground for temporary storage when a worksite is unmanned (such as during overnight periods). For these reasons, the top of the generator may be provided with an eyelet for attachment to a crane hook.

At least one drawback with the typical crane hook eyelet is that the eyelet tends to be large and bulky to accommodate large crane hooks. Furthermore, the conventional eyelet, which is rigidly attached to the generator frame, projects well above a top surface of the power generation unit to ease attachment to the crane hook. However, due to projection of the eyelet, the power generation unit usually has a relatively tall profile that may prevent storage of the power generation unit in smaller or low profile storage areas. Additionally, the conventional eyelet is simply in the way most of the time since it is only used occasionally.

What is needed in the industry is a foldable, low-profile attachment system that, when extended, provides sufficient strength and durability for repeated attachments and hoisting by cranes.

### BRIEF SUMMARY OF THE DISCLOSURE

The present disclosure is directed in general to a lightweight, compact and foldable lift kit assembly, which is attached to generators, trailers, and other portable equipment for hoisting and repositioning by cranes and the like.

According to various embodiments of the disclosure, the lift kit assembly generally includes a lift kit ring connected to one or more piston assemblies, each having a spring constant. The spring constant urges the lift kit ring into a locked, upright position for connection to a crane hook. However, the piston assemblies readily yield to stowage forces to fold or retract the lift kit ring generally flush with a surface of a generator. Thus, the lift ring may be movable between an upright lift position and a flush storage position.

More specifically, when a lift kit ring, or eye, of the lift kit assembly is not in use, the pistons are retracted within the respective assemblies, and the ring is folded down parallel to the top surface of the generator (in a storage position). The rotational movement of the lifting ring and the attached pistons is restricted to prevent the ring from making contact with the generator's top surface, such as its gas tank. From this storage position, the ring and pistons may be rotated 90 degrees to an upright position, with the pistons remaining compressed within their cylinders. In the upright lift position, the lifting ring is perpendicular to the generator's top surface. Further rotational movement is restricted beyond this upright position so the total rotational movement when the pistons are retracted is 90 degrees, from a parallel to a perpendicular position in relation to the top of the generator (and vice versa).

Once the lifting ring is rotated to the upright position, by lifting on the eye, the pistons may be extended outward, which moves the eye further from the generator. At its peak, further rotational movement of the ring and the pistons is prevented, and the assembly remains in its fully extended and locked position. In this position, the ring may be attached to a lifting mechanism of the user's choice (e.g., a hook attached to a crane), and the generator may be raised. The ring remains extended away from the generator in its upright locked position due to the lifting tension on the apparatus, when the generator is suspended in the air.

When returned to the ground and the upward tensional force of the crane hook is removed, the ring and pistons remain in the fully extended locked position. To return the lift kit assembly to its storage position, a small downward force may be applied to the ring, which retracts the pistons. As soon as the pistons return to their retracted position, the assembly is unlocked, meaning that the ring may be rotated 90 degrees to its storage position.

As will be described in greater detail below along with other features and aspects of the disclosure, the various components and elements of the lift kit assembly and its equivalents are simple to manufacture, install and use. Other advantages of the various embodiments and their equivalents according to the disclosure will be apparent from the following description and the attached drawings, or can be learned through practice of the embodiments and their equivalents.

### BRIEF DESCRIPTION OF THE DRAWINGS

A full and enabling disclosure of the present disclosure, including the best mode thereof to one skilled in the art, is set forth more particularly in the remainder of the specification, including reference to the accompanying figures, in which:

FIG. 1 is a top perspective view of a lift kit assembly in an extended (or “lift”) position, according to an aspect of the disclosure;

FIG. 2 is a perspective view of the lift kit assembly in a flush (or “storage”) position, according to an aspect of the disclosure;

FIG. 3 is a schematic perspective view of the lift kit assembly as in FIG. 1; and

FIG. 4 is an exploded view of portions of the lift kit assembly as in FIG. 1.

### DETAILED DESCRIPTION OF THE DISCLOSURE

Detailed reference will now be made to the drawings in which examples of the present disclosure are shown. The detailed description uses numerical designations to refer to features of the drawings. Like or similar designations of the drawings and description have been used to refer to like or similar parts of the disclosure where possible.

The drawings and detailed description provide a full and written description of the examples in the disclosure, and of the manner and process of making and using these examples, so as to enable one skilled in the pertinent art to make and use them, as well as the best mode of carrying out the disclosure. The examples set forth in the drawings and detailed description are provided by way of explanation only and are not meant as limitations of the disclosure. The present disclosure thus includes any modifications and variations of the following examples as come within the scope of the appended claims and their equivalents.

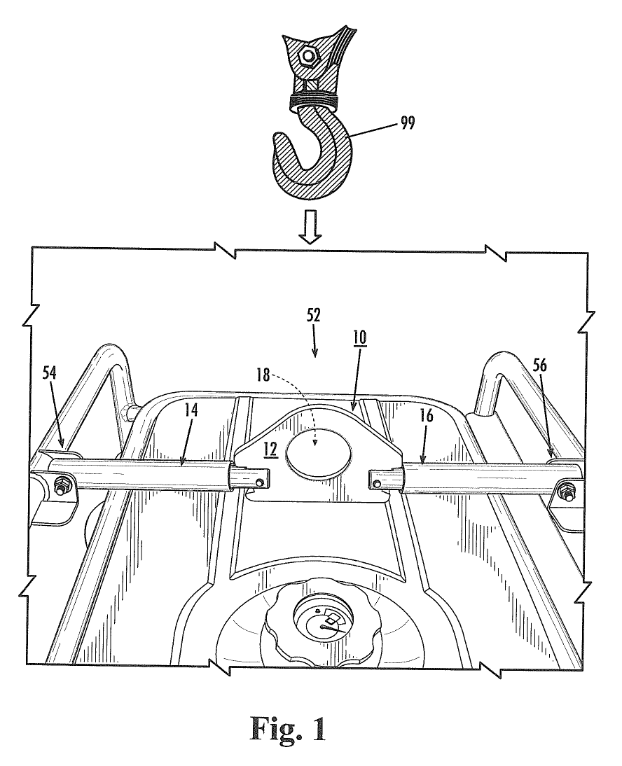

FIGS. 1-4 generally show an embodiment of a lift kit assembly, broadly designated by the element number 10, for use with a generator 52 or other portable power generation and construction equipment. As used herein, any reference to “the generator” or “generator 52” or the like is intended to broadly encompass any piece of portable equipment that may be advantageously moved with a crane, unless specifically stated otherwise. The lift kit assembly 10 may be used to reposition the generator 52 from one area to another, for example, at a worksite. Additionally, the lift kit assembly 10 may be used to stow the generator 52 temporarily above ground to organize a work area or during non-working hours to protect the generator 52 from theft or damage.

As used herein, the term “lift position” refers to the orientation of the lift kit assembly 10 that enables the engagement of a crane hook 99 for lifting the portable equipment (as shown in FIG. 1). In the lift position, the lift ring 12 is perpendicular, or substantially perpendicular, to the top surface (58) of the portable equipment 52, and the piston assemblies 14, 16 are fully extended.

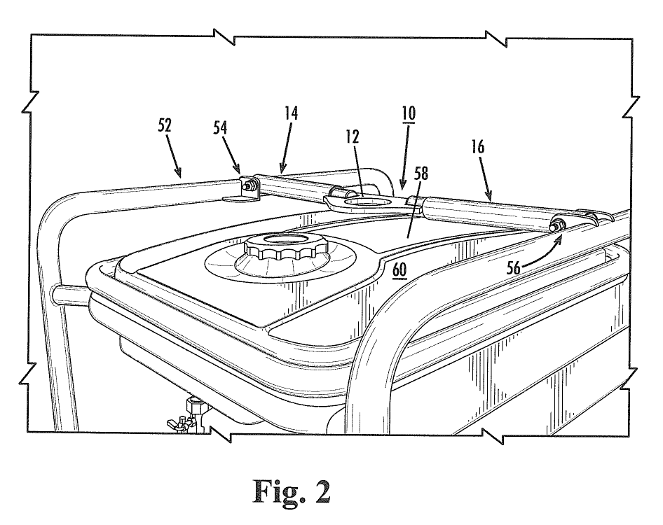

The term “storage position” refers to the orientation of the lift kit assembly 10, in which the piston assemblies 14, 16 are retracted and the lift ring 12 is parallel, or substantially parallel, to the top surface (58) of the portable equipment 52 (as shown in FIG. 2), making the portable equipment 52 ready for storage.

It is to be understood that the lift ring 12 may or may not be exactly perpendicular or parallel to the top surface (58) of the portable equipment 52, or to all portions of the top surface (58), depending upon the contours of the top surface (58). For this reason, the terms “substantially perpendicular” and “substantially parallel” are used to indicate the position of the lift ring 12, relative to a majority of the top surface (58).

FIG. 1 shows the lift kit assembly 10 in an extended or “lift” position. As illustrated, the exemplary lift kit assembly 10 generally includes a lift ring 12 and one or more piston assemblies 14, 16, which are attached, at one end, to the lift ring 12 and, at the opposite end, to respective connection or holding portions 54, 56 of the generator 52. The crane hook 99 may be hooked through an aperture or opening 18 of the lift ring 12 to move or stow the generator 52 as introduced above.

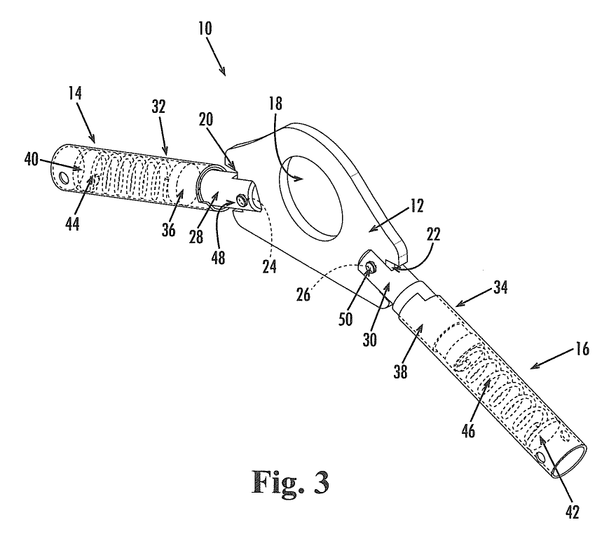

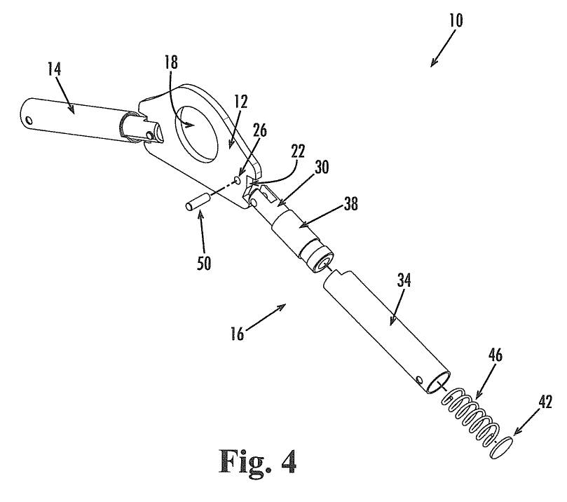

The lift kit ring 12 may have a generally flat profile, or planar surface, through which planar surface the opening 18 may be provided. The ring 12 may have the shape of a pentagon (with or without rounded edges) or some other shape, as may accommodate the centrally located opening 18 and the attachment of the piston assemblies 14, 16 on opposite ends thereof. For connection of the piston assemblies 14, 16, the opposite ends of the ring 12 are provided with pin-receiving bores (24, 26, shown in FIGS. 3 and 4), which are aligned along a transverse axis of the lift ring 12. Also located along this imaginary transverse axis are double notches (20, 22, also shown in FIG. 3) that facilitate the articulated movement of the oppositely disposed piston assemblies 14, 16. The opening 18 may be positioned along a centrally located longitudinal axis of the lift ring 12 and may be positioned slightly higher than the aforementioned transverse axis along which the pin bores (24, 26) are located, such that the transverse axis is tangential to the bottom of the opening 18. Although the opening 18 is shown as being circular in shape, other shapes (e.g., other polygonal shapes) may instead be used.

The piston assemblies 14, 16 include a spring (44, 46, as shown in FIG. 3) therein, and the spring constant of these springs 44, 46 biases the lift ring 12 into an upright position. In this upright or “lift” position, when the crane hook 99 engages the lift ring 12, the upward movement of the crane hook 99 causes the pistons 14, 16 to be extended outwardly, ensuring that the lift ring 12 is optimally located in a perpendicular orientation relative to the upper surface (58) of the generator 52. The rotation of the lift ring 12 is limited to 90 degrees and “locks” at this angle, due to the lifting tension on the assembly 10. Thus, the lift ring 12 remains in a position perpendicular to the top surface (58) of the generator, even when the generator 52 is being hoisted or suspended.

Even when the generator 52 is returned to the ground and the upward tensional force is removed, the lift ring 12 and the pistons 14, 16 remain in their upright and locked position. By applying a downward force to the ring 12, the piston assemblies 14, 16 are retracted, and the lift kit assembly 10 may be rotated to a storage position, as described above and as illustrated in FIG. 2. As shown, the ring 12 may be rotated to a position substantially flush with, or parallel to, a top surface 58, such as a gas tank 60, of the generator 52. Accordingly, the lift kit assembly 10 is folded out of the way when not needed, and stowage of the generator 52 is also made easier by lowering a profile of the generator 52. Additionally, because the lift kit assembly 10 is readily collapsible to a flat and unobtrusive state, the necessity of removing the assembly 10 from the generator 52 to reduce its overhead profile is negated.

The lift kit assembly 10 is most clearly shown in FIG. 3. As introduced, the lift kit assembly 10 broadly includes the lift ring 12 to which are connected, on opposite ends, the piston assemblies 14, 16 (in this example). As shown, the ring 12 includes the aperture or opening 18, introduced above, for receiving the crane hook (99). More particularly, the ring 12 may also include double notches or grooves 20, 22 (more clearly seen in FIG. 4) for articulating interaction with respective connecting rod clevels, or cylinders, 28, 30. The clevels 28, 30 are inserted in respective connecting cannulations, or cylinder barrels, 32, 34.

Root cannulations, or tubes, 36, 38 are positioned over the connecting rod clevels 28, 30 before the clevels 28, 30 are housed within the connecting cannulations 32, 34. Respective root cannulations, or tubes, 36, 38 and respective roots, or plates, 40, 42 compress respective spring elements 44, 46 therebetween, when the piston assemblies 14, 16 are to be retracted. As shown, the connecting rod clevels 28, 30 are connected to the lift ring 12 by respective pins 48, 50 inserted through the pin bores 24, 26 in the lift ring 12, and the piston assemblies 14, 16 are in turn connected by bolts or other attachment devices (via bores through one end of the connecting cannulations 32, 34, at the end opposite their connection point to the lift ring 12) to the holding portions 54, 56 of the generator 52.

As further shown in FIG. 3, the piston assemblies 14, 16 are pivotable within the double notches 20, 22 for articulating interaction to either lock the ring 12 in flush or upright positions as discussed with respect to FIGS. 1 and 2 above.

With reference now to FIG. 4, a portion of the lift kit assembly 10 is shown most clearly in an exploded view. In particular, only elements of the piston assembly 16 are shown for clarity. The piston assembly 14 is similarly constructed.

In this illustration, the lift ring 12 is connected to the piston assembly 16 by inserting the pin 50 through a pin bore in one end of the connecting rod clevel 30 and the pin bore 26 of the lift ring 12, after the connecting rod clevel 30 is positioned through the root cannulation 38. As further shown in FIG. 4, the connecting rod clevel 30 (and the surrounding root cannulation 38) are then inserted into one end of the connecting cannulation 34 to compress the spring element 46 housed within the opposite end of the connecting cannulation 34. The spring 46 occupies a space between the end of the connecting rod clevel 30 and the root 42 housed at an end of the connecting cannulation 34, opposite the attachment of the pin 50. As shown in FIG. 1, the connecting cannulation 34 is connected to the holding portion 56 of the generator 52 by bolts inserted through the holes in the end of the connecting cannulation 34 and a corresponding bracket of the holding portion 56 of the generator 52.

Although reference has been made herein to a spring piston assembly, it is contemplated that similar results may be achieved through use of other types of piston assemblies.

The foregoing is a description of various embodiments of the disclosure that are provided here by way of example only. Although the lift kit assembly has been described with referenced presently preferred embodiments and examples thereof, other embodiments and examples may perform similar functions and/or achieve similar results. All such equivalent embodiments and examples are within the spirit and scope of the present disclosure and are intended to be covered by the appended claims and their equivalents. Moreover, although specific terms are employed herein, they are used in a generic and descriptive sense only and are not for purposes of limitation.

That which is claimed is:

1. A lift kit assembly comprising:
a lift kit ring, having an aperture therethrough for receipt of a crane hook;
at least one spring piston assembly having a spring constant, a connection end, and a root end, the connection end being attached to the lift kit ring and the root end being attached to a portable generator;
the lift kit assembly being rotatable from a lifting position to a storage position, the lifting position being defined by the at least one piston assembly being extended and the lift kit ring being perpendicular to the upper surface of the generator, the spring constant of the at least one spring piston assembly biasing the lift kit ring to the lifting position, and the storage position being defined by the at least one piston assembly being retracted and the lift kit ring being substantially parallel to the upper surface of the generator,
the at least one piston assembly being readily retracted, upon application of a downward force, to permit rotation from the lifting position to the storage position.

2. The lift kit assembly of claim 1, wherein the lift kit assembly comprises two spring piston assemblies, a second spring piston assembly being attached to the lift kit ring opposite a location where a first spring piston assembly is attached to the lift kit ring.

3. The lift kit assembly of claim 2, wherein the lift kit ring comprises a planar surface having opposite ends, the aperture therethrough being centrally located between the opposite ends, and the ends having a double notch therein for articulated movement of the spring piston assemblies.

4. The lift kit assembly of claim 1, wherein the connection end of the spring piston assembly is attached to the lift ring via a pin positioned through a bore in the spring piston assembly and a corresponding bore in the lift ring.

5. The lift kit assembly of claim 1, wherein the spring piston assembly comprises a connecting rod clevel, a root cannulation, a connecting cannulation, a root, and a spring,
the connecting rod clevel being attached to the lift ring;
the root cannulation being fitted over the connecting rod clevel and surrounding a portion of the connecting rod clevel;
the connecting cannulation including the root end that is attached to the portable generator;
the root being located within the connecting cannulation at an end distal to the lift ring; and
the spring being positioned with the connecting cannulation between the root cannulation and the root.

6. The lift kit assembly of claim 5, wherein the connecting cannulation is attached to the portable generator via a bolt positioned through a bore in the connecting cannulation and a corresponding bracket of the portable generator.

7. The lift kit assembly of claim 1, wherein the rotation of the lift kit assembly is limited to a 90-degree rotation.
